(19) United States
(12) Patent Application Publication
(10) Pub. No.: US 2006/0286400 A1
(43) Pub. Date: Dec. 21, 2006

(54) Substrate with alloy finish and method of making

(75) Inventors: Paul McDaniel, Jonesborough, TN (US); Randy Beets, Bulls Gap, TN (US); Johnny Smelcer, Midway, TN (US); Albert Giles, Greeneville, TN (US)

Correspondence Address: Doreen J. Gridley;ICE MILLER, One American Square, Box 82001, Indianapolis, IN, 46282-0200, US

(73) Assignee: Jarden Zinc Products, Inc., Greeneville, TN (US)

(21) Appl. No.: 11/155,426

(22) Filed: Jun. 17, 2005

(51) Int. Cl. B32B 19/00; B32B 15/00

(52) U.S. Cl. 428/689; 428/615

(57) ABSTRACT

Substrates having an alloy finish and methods of producing the same. The finished product according to one embodiment of the present invention is a substrate having an alloy finish comprising two or more metals, and is made by the method of the present invention. Generally, the method of the present invention comprises provision of a substrate, electroplating two or more metals onto the substrate, and then baking the plated substrate to result an alloy of the plated metals through diffusion. Substrates made according to the present invention can be covered with a variety of types of alloy finishes, and a variety of characteristics of such finishes can be achieved. The method of the present invention uses steps of electroplating and heating that are well-known in the art, and does not require the use of toxic, cyanide-based plating baths.

### BACKGROUND OF THE INVENTION

This invention relates to substrates having an alloy finish, and, in particular, to creation of alloy finishes using diffusion techniques.

Generally, two methods have been used in the prior art to produce metallic objects having a bronze, brass, white, or silvery appearance. First, an object of solid brass, solid bronze, or a white solid alloy, such as stainless steel or cupronickel, may be produced. Alternately, brass, bronze, or an alloy having a white or silvery appearance may be electroplated onto a base material comprised of metal or non-metal. Rising metal prices have made the use of solid brass, solid bronze, or nickel-bearing alloys cost-prohibitive for many items, such as low-denomination coinage, for example. Use of an alloy plating over lower-cost base materials, such as zinc or steel, provides a substantial cost advantage when compared to solid alloy objects. However, alloy plating still presents many difficulties in analysis and control. Small chemical changes in the brass, bronze, or other alloy plating baths can result in dramatic shifts in the alloy composition. Such shifts can also lead to deposits with different physical, mechanical, metallurgical, and/or electronic properties than those desired of the object. Therefore, it is desired to provide an object with an alloy finish, such as a brass, bronze, white, or silvery finish, that is lower in cost to produce than the cost to produce solid alloys, and is produced by a method that results in a consistent alloy composition.

Another issue arising with brass, bronze, or other alloy plated objects is the use of cyanide-based plating paths. These toxic baths are usually used in electroplating brass, bronze, tin-zinc, and many other alloys. Thus, it is desired to provide a method for providing an object having an alloy finish that does not require the use of cyanide-based plating baths.

Coinage is often created by covering a steel blank. An alternate material to steel that is desirable is zinc. Zinc is reasonably priced and is less harsh on dies used for the coinage, thereby extending the coining die life. The desired weight of the coinage, such as is desired in vending machines, for example, can also be maintained with a zinc core. In addition, a brass finish on a steel base must generally be at least 25 μm in thickness to alleviate corrosion concerns, whereas a brass finish on zinc need only be about 8 μm to about 15 μm thick to provide a quality product. Although bronze has been plated successfully over zinc and used for coinage application, brass has not. Efforts to produce a brass-plated zinc coin have resulted in deposits that crack when coining is attempted. Therefore, it is desired to provide a method to create coinage having an alloy finish over a zinc base or steel base, and that such method permit for the creation of a bronze, brass, white or silvery finish.

Other objects made with steel or other metal cores are candidates for an alternate zinc core, and for the creation of a bronze, brass, white, or silvery finish. Such objects include keys, tokens, medallions, and other small, non-nesting metal parts that are amenable to bulk-treatment operations, such as barrel plating and mass finishing. It is therefore desired to provide a method for producing a bronze, brass, white, or silvery appearance on steel, zinc, or other metal cores for such objects.

### SUMMARY

The present invention comprises substrates having an alloy finish, and methods of making the same. In one embodiment, an article comprises a substrate or planchet having an alloy finish thereon, whereby the alloy finish is created using the method of the present invention. The method of the present invention includes the steps of electroplating a layer of a first metal onto the substrate or planchet, electroplating a second layer of a second metal onto the first electroplated layer, and heating the combination of the substrate or planchet and the first and second electroplated layers to produce an alloy finish. The alloy finish comprises the metals of both the first and second electroplated layers.

Various embodiments are presented herein to produce an object with a brass, bronze, white, or silvery appearance. Those embodiments includes cores made of steel, zinc, or other metals or metal alloys, and created alloys of brass (copper-zinc), bronze (copper-tin or copper-tin-zinc), tin-zinc, nickel-zinc, and nickel-tin.

The method of present invention uses processes which, individually, are well-known in the art and do not require any special equipment to perform. The method also does not require the use of toxic cyanide-based plating baths. Also, the method does not require plating of alloys, which are difficult to analyze and to control. Further, the method can be used produce articles having a variety of alloy finishes, and to vary the characteristics of those finishes by controlling the metals deposited, the thickness of the layers, and the time and temperature of the heating step.

### BRIEF DESCRIPTION OF THE DRAWINGS

FIG. 1 shows a cross-sectional view of one embodiment of a substrate of the present invention having electroplated layers adhered thereto prior to creation of an alloy finish from the electroplated layers.

FIG. 2 shows a cross-sectional view of one embodiment of a substrate of the present invention having an alloy finish adhered thereto.

### DETAILED DESCRIPTION

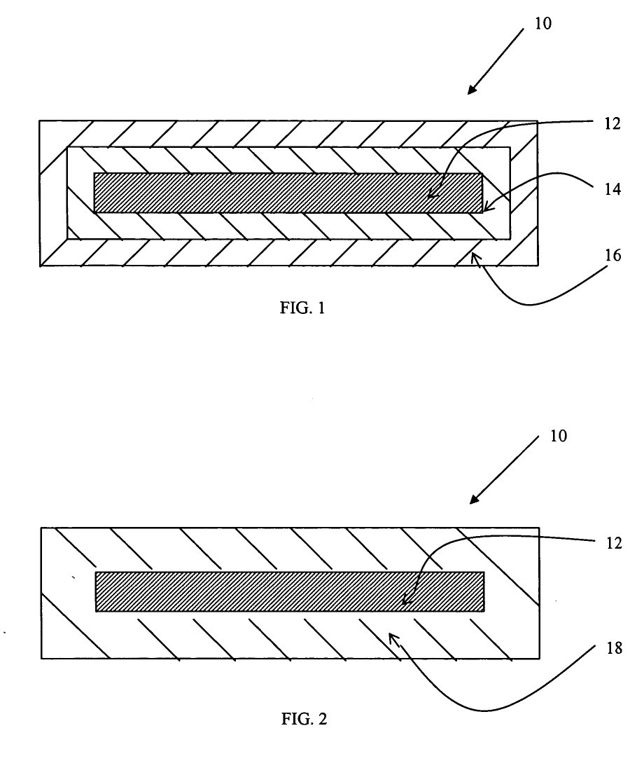

Referring now to FIG. 1, there is shown a cross-sectional view of one embodiment of a substrate of the present invention having electroplated layers adhered thereto prior to the creation of an alloy finish from the electroplated layers. In this embodiment, article 10 comprises substrate 12, first electroplated layer 14, and second electroplated layer 16. As is explained in greater detail herein in association with FIG. 2 and the description of the method of the present invention, first electroplated layer 14 of metal is electroplated to substrate 12 to cover the exposed surfaces of substrate 12. Second electroplated layer 16 of metal is electroplated to the combination of substrate 12 and first electroplated layer 14 to cover the exposed surfaces of first electroplated layer 14. Article 10 of FIG. 1 has not yet been fully processed according to the method of the present invention to result in an alloy finish on substrate 12.

FIG. 2 shows a cross-sectional view of one embodiment of a substrate of the present invention having an alloy finish adhered thereto. In this embodiment, article 10 of FIG. 1 has been further processed according to the method of the present invention to produce alloy finish layer 18. Alloy finish layer 18 comprises diffused contents of the metal of first electroplated layer 14 and the metal of second electroplated layer 16 to form alloy finish 18.

According to one embodiment, the method of the present invention comprises the following steps:
a. The starting material comprises any article(s) (“the work”) capable of being electroplated.

A typical example is a metal blank (planchet) in the approximate shape and size of a key, coin, token, medallion, or similar item to be manufactured. According to one embodiment of the present invention, the metal blank comprises zinc or a zinc alloy. A quantity of the articles is loaded into a plating barrel or onto a plating rack. The barrel or rack is then processed through a series of cleaners and rinses capable of removing any contaminants, such as dirt or oil, which may be present on the work. Depending upon the basis metal used for the metal blank, additional processing steps may be required, such as acid dips or, in the case of aluminum, a “zincate” immersion deposit. In the case of non-metallic work, various preparatory processes are available which result in the formation of a metallic surface, which can then be plated in a conventional manner.
b. The final preparatory step is a “strike,” which scrubs the metal surfaces with hydrogen bubbles and simultaneously deposits a thin, protective layer (from about 0.1 μm to about 1.0 μm) of metal, usually copper. Other metal strikes, predominantly nickel, are used in certain applications to ensure good adhesion to certain difficult-to-plate metals.
c. After the strike has been applied to the work, the barrel or rack is then moved into the first plating bath, usually copper. If an alkaline cyanide copper strike is used, the barrel or rack may be moved directly into an alkaline cyanide copper plating bath. However, if the contents of the strike and plating bath are chemically incompatible (e.g. cyanide copper strike followed by acid copper plating), thorough rinsing must take place before the work may be moved into the copper plating bath.
d. Once in the copper plating bath, the work is electroplated until the desired plating thickness is reached. Generally, the plating thickness will be from about 8 μm to about 25 μm. Greater thicknesses are acceptable, provided this does not cause the work pieces to become too large for subsequent processing or forming steps or end use.
e. After the copper plating cycle is complete, the barrel or rack is moved through a series of rinses to remove the residual copper plating solution. It is then placed into a second plating bath, usually zinc or tin. This bath deposits a layer of the second metal, firmly bonded to the first. The required plating thickness is determined in accordance with the particular alloy, color, or other characteristic(s) desired in the end product. Generally, the plating thickness will be from about 0.1 μm to about 5 μm, with the optimum value dependent upon the type of metal alloy to be produced.
f. If desired, additional plated metal layers may be added, with the intention of producing a ternary (three metals) or higher alloy. In such instances, the work must be thoroughly rinsed between each individual plating operation to prevent cross-contamination of the plating baths.
g. After the plating cycles are complete, the barrel or rack is moved through a series of rinses to remove the residual plating solution. Anti-staining agents may also be applied. The work is then dried and collected for subsequent processing.
h. The diffusion cycle consists of baking the work per a temperature/time cycle appropriate to the base material, the alloy being formed, and the end properties desired. A batch process or continuous belt process may be used to move the work through a furnace. An inert or reducing atmosphere may be used in the furnace to minimize oxidation. In the example wherein the first electroplated layer comprises copper, and wherein the second electroplated layer comprises, zinc or tin, the alloy finish resulting from this diffusion cycle comprises an alloy of the metals comprising the first and second electroplated layers, i.e., an alloy of copper and zinc, or an alloy of copper and tin.
i. In some instances, the work pieces are burnished or otherwise polished to produce a bright finish. In other instances, the as-diffused appearance may be sufficient for the end use.
j. The work is then ready for subsequent processing, if any. In the case of coins, tokens, medallions, and similar items, the blanks are coined into their finished appearance using dies and presses as is well-known in the art. Two specific examples of application of the method of the present invention to produce coinage are as follows:
(1) Zinc coin blanks are placed in a plating barrel and processed through cleaners and a cyanide copper strike bath to ensure good plating adhesion. The barrel is then moved into a copper plating solution, and copper is electroplated until its thickness at the center of each blank is about 15 μm (0.0006 in.). The barrel is then removed from the copper plating bath and rinsed thoroughly in water. Then the barrel is placed in a zinc plating solution, and zinc is electroplated until its thickness at the center of each blank is about 0.25 μm (0.00001 in.). The barrel is then removed from the zinc plating bath and rinsed thoroughly in water. The blanks are then removed from the barrel and dried. Then they are placed on the moving belt of a furnace with the hot zone set at about 371° C. (700° F.). The belt speed is adjusted so that the total residence time in the furnace (including the cooling zone) is about 25 minutes. A nitrogen/hydrogen (reducing) atmosphere is used in the furnace to prevent excessive oxidation of the surfaces. After the blanks come out of the furnace, they are placed in a centrifugal burnishing machine with stainless steel media and burnished to a bright luster, with the aid of a citric acid-based burnishing compound. The blanks are then coined using a die set and a press, producing an attractive brass-colored coin, token, or medallion with a greenish hue.
(2) Carbon steel coin blanks are placed in a plating barrel and processed through cleaners and a cyanide copper strike bath to ensure good plating adhesion. The barrel is then moved into a copper plating solution, and copper is electroplated until its thickness at the center of each blank is about 25 μm (0.001 in.). The barrel is then removed from the copper plating bath and rinsed thoroughly in water. Then the barrel is placed in a zinc plating solution, and zinc is electroplated until its thickness at the center of each blank is about 0.7 μm (0.00003 in.). The barrel is then removed from the zinc plating bath and rinsed thoroughly in water. The blanks are then removed from the barrel and dried. Then they are placed on the moving belt of a furnace with the hot zone set at about 482° C. (900° F.). The belt speed is adjusted so that the total residence time in the furnace (including the cooling zone) is about 25 minutes. A nitrogen/hydrogen (reducing) atmosphere is used in the furnace to prevent excessive oxidation of the surfaces. After the blanks come out of the furnace, they are placed in a centrifugal burnishing machine with stainless steel media and burnished to a bright luster, with the aid of a citric acid-based burnishing compound. The blanks are then coined using a die set and a press, producing an attractive brass-colored coin, token, or medallion with a greenish hue.

To demonstrate the versatility of this invention, a brass finish with a yellowish hue can be produced exactly as in (2) above, with the following modifications: zinc plating thickness of about 4.7 μm (0.00019 in.), and a furnace temperature about 704° C. (1300° F.). Indeed, a wide variety of characteristics of finishes can be produced by the method of the present invention simply by varying the relative plating thicknesses, the furnace temperature, and the belt speed (time in the furnace).

It will be appreciated by those of skill in the art that the variations of this invention are nearly infinite, with the wide variety of basis metals (metals or metal alloys of the substrate) and plated coatings available (metals of the first and of the second electroplated layers to produce an alloy of these metals). Among the more common useful alloy finishes that are feasible to produce by this method include brass (copper-zinc), bronze (copper-tin or copper-tin-zinc), and tin-zinc. Other alloys, such as nickel-zinc, and nickel-tin, may also be feasible.

It will also be appreciated that the substrate and method of the present invention may be used to produce an alloy finish having more than two components as illustrated in FIG. 1 and FIG. 2, and as discussed in association with the examples set forth hereinabove. More than two electroplated layers are contemplated to be within the scope of the present invention. For example, a zinc substrate may be electroplated with a layer of copper, a layer of tin, and a layer of zinc, and then heated to diffuse the metals of the first, second, and third layers to produce a zinc substrate having a ternary bronze alloy finish.

It will be further appreciated that the substrate need not comprise a pure metal, but may comprise carbon steel or a metal alloy and still be within the scope of the present invention. The limitations on the metals of the substrate and of the electroplated layers are primarily driven by the ability of the metal of the first electroplated layer to adhere to the substrate, and to the subsequent metals of the subsequent layers to adhere to the previous layer. The metals of the electroplated layers must also be conducive to diffusion when exposed to appropriate temperatures to produce the alloy finish.

It will be further appreciated that the alloy finished substrate of the present invention comprises lower materials costs than solid alloy objects. It will be still further appreciated that the method of the present invention does not require the use of toxic, cyanide plating baths. It will be yet further appreciated that, according to the present invention, an alloy finished article can be produced without requiring that an alloy be electroplated onto the substrate, thereby avoiding the difficulties in analysis and control of alloy plating.

It should be noted that the plating processes used in the method of the present invention are standard processes, requiring no special additives or equipment. Plating baths may be alkaline, acid, or neutral, depending upon the preferences of the plater and of the waste treatment specialist. Current density, temperature, and other plating process parameters are also in accordance with standard plating practice. It is, however, recommended that the plating processes be operated with minimal use of brighteners. Brighteners tend to make deposits brittle and may interfere with the diffusion step in the method of the present invention.

It will be appreciated that the method of the present invention may result in diffusion of the first electroplated layer into the substrate. In many instances, such diffusion may not be desired. Thus, if such diffusion is not desired, the time/temperature cycles of the heating step should be selected to minimize this secondary diffusion.

It will also be appreciated by those of skill in the art that the method of the present invention can be used to produce a variety of types of articles having an alloy finish. The invention is useful for small, non-nesting metal parts that are amenable to bulk-treatment operations, such as barrel plating and mass finishing (e.g., vibratory bowl deburring, or centrifugal disc burnishing). Specific examples of such articles include: blanks used for coinage, tokens, and medallions; keys and lock components; threaded fasteners (screws, bolts, nuts, etc.); and other small hardware items (knobs, handles, brackets, etc.).

The present invention can be further modified within the scope and spirit of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

We claim:

1. A method for producing an alloy finish on a substrate, comprising the steps of:
providing a substrate comprising a first metal or metal alloy, the substrate having at least one exposed surface;
electroplating a first layer of a second metal onto the at least one exposed surfaces of the substrate, wherein the second metal consists of one of the group of copper, tin, zinc, or nickel;
electroplating a second layer of a third metal onto the first electroplated layer, wherein the third metal consists of one of the group of zinc, nickel, or tin, but different from the second metal; and
heating the combination of the substrate with the first and second electroplated layers to allow the first and second electroplates layer to diffuse, thereby producing an alloy finish on the substrate, the alloy finish comprising the combination of the second metal and the third metal.

2. The method of claim 1, further comprising the step of:
striking the substrate before the step of electroplating the first layer.

3. The method of claim 1, further comprising the step of:
rinsing the first electroplated layer before the step of electroplating the second layer.

4. The method of claim 1, further comprising the step of:
rinsing the second electroplated layer before the heating step.

5. The method of claim 1, further comprising the step of placing the alloy finished substrate into a die.

6. A method for producing a brass finish on a substrate, the method comprising the steps of:
providing a substrate comprising metal or metal alloy, the substrate having at least one exposed surface;
electroplating a first layer of copper onto the at least one exposed surfaces of the substrate;
electroplating a second layer of zinc onto the first electroplated layer; and
heating the combination of the substrate, the first electroplated layer, and the second electroplated layer to produce a brass alloy finish on the substrate.

7. A method for producing a bronze finish on a substrate, the method comprising the steps of:
providing a substrate comprising metal or metal alloy, the substrate having at least one exposed surface;
electroplating a first layer of copper onto the at least one exposed surfaces of the substrate;
electroplating a second layer of tin onto the first electroplated layer; and
heating the combination of the substrate, the first electroplated layer, and the second electroplated layer to produce a bronze finish on the substrate.

8. A method for producing a bronze finish on a substrate, the method comprising the steps of:
providing a substrate comprising metal or metal alloy, the substrate having at least one exposed surface;
electroplating a first layer of copper onto the at least one exposed surfaces of the substrate;
electroplating a second layer of tin onto the first electroplated layer;
electroplating a third layer of zinc onto the second electroplated layer; and
heating the combination of the substrate, the first electroplated layer, the second electroplated layer, and third electroplated layer to produce a bronze finish on the substrate.

9. A method for producing a silvery or white appearance on a substrate, the method comprising the steps of:
providing a substrate comprising metal or metal alloy, the substrate having at least one exposed surface;
electroplating a first layer of tin onto the at least one exposed surfaces of the substrate;
electroplating a second layer of zinc onto the first electroplated layer; and
heating the combination of the substrate, the first electroplated layer, and the second electroplated layer to produce a silvery or white appearance on the substrate.

10. A method for producing a silvery or white appearance on a substrate, the method comprising the steps of:
providing a substrate comprising metal or metal alloy, the substrate having at least one exposed surface;
electroplating a first layer of nickel onto the at least one exposed surfaces of the substrate;
electroplating a second layer of zinc onto the first electroplated layer; and
heating the combination of the substrate, the first electroplated layer, and the second electroplated layer to produce a silvery or white appearance on the substrate.

11. A method for producing a silvery or white appearance on a substrate, the method comprising the steps of:
providing a substrate comprising metal or metal alloy, the substrate having at least one exposed surface;
electroplating a first layer of nickel onto the at least one exposed surfaces of the substrate;
electroplating a second layer of tin onto the first electroplated layer; and
heating the combination of the substrate, the first electroplated layer, and the second electroplated layer to produce a silvery or white appearance on the substrate.

12. An article produced by the method of claim 1.

13. A coin produced by the method of claim 1.

14. A key produced by the method of claim 1.

15. A token produced by the method of claim 1.

17. A medallion produced by the method of claim 1.

18. A lock component produced by the method of claim 1.

19. A fastener produced by the method of claim 1.

20. A small hardware item produced by the method of claim 1.

21. A non-nesting metal part produced by the method of claim 1.

22. An article, comprising:
a substrate comprising metal or metal alloy, the substrate having at least one exposed surface;
an alloy finish on the at least one exposed surfaces of the substrate, the alloy finish formed by the step of
electroplating a first layer of a first metal onto the at least one exposed surfaces of the substrate, wherein the first metal consists of one of the group of copper, tin, zinc, or nickel,
electroplating a second layer of a second metal onto the first layer, wherein the second metal consists of one of the group of zinc, nickel, or tin, but different from the first metal, and
heating the first and second layers together to allow the first and second layers to diffuse together to form an alloy finish comprising the first and second metals.

23. An article, comprising:
a substrate comprising metal or metal alloy, the substrate having at least one exposed surface;
a brass alloy finish on the at least one exposed surfaces of the substrate, the brass alloy finish formed by the steps of
electroplating a first layer of copper onto the at least one exposed surfaces of the substrate,
electroplating a second layer of zinc onto the first electroplated layer, and
heating the first and second layers together to allow the first and second layers to diffuse together to form the brass alloy finish comprising the copper and the zinc.

24. An article, comprising:
a substrate comprising metal or metal alloy, the substrate having at least one exposed surface; and
a bronze alloy finish on the at least one exposed surfaces of the substrate, the bronze alloy finish formed by the steps of
electroplating a first layer of copper onto the at least one exposed surfaces of the substrate,
electroplating a second layer of tin onto the first electroplated layer, and
heating the first and second layers together to allow the first and second layers to diffuse together to form the bronze alloy finish comprising the copper and the tin.

25. An article, comprising:
a substrate comprising metal or metal alloy, the substrate having at least one exposed surface; and
a bronze alloy finish on the at least one exposed surfaces of the substrate, the bronze alloy finish formed by the steps of
electroplating a first layer of copper onto the at least one exposed surfaces of the substrate,
electroplating a second layer of tin onto the first electroplated layer,
electroplating a third layer of zinc onto the second electroplated layer, and
heating the first, second, and third layers together to allow the first, second, and third layers to diffuse together to form the bronze alloy finish comprising the copper, the tin, and the zinc.

26. An article, comprising:
a substrate comprising metal or metal alloy, the substrate having at least one exposed surface; and
a white or silvery alloy finish on the at least one exposed surfaces of the substrate, the alloy finish formed by the steps of
electroplating a first layer of tin onto the at least one exposed surfaces of the substrate,
electroplating a second layer of zinc onto the first electroplated layer, and
heating the first and second layers together to allow the first and second layers to diffuse together to form the alloy finish comprising the tin and the zinc.

27. An article, comprising:
a substrate comprising metal or metal alloy, the substrate having at least one exposed surface; and
a silvery or white alloy finish on the at least one exposed surfaces of the substrate, the alloy finish formed by the steps of
electroplating a first layer of nickel onto the at least one exposed surfaces of the substrate,
electroplating a second layer of zinc onto the first electroplated layer, and
heating the first and second layers together to allow the first and second layers to diffuse together to form the alloy finish comprising the nickel and the zinc.

28. An article, comprising:
a substrate comprising metal or metal alloy, the substrate having at least one exposed surface; and
a white or silvery alloy finish on the at least one exposed surfaces of the substrate, the alloy finish formed by the steps of
electroplating a first layer of nickel onto the at least one exposed surfaces of the substrate,
electroplating a second layer of tin onto the first electroplated layer, and
heating the first and second layers together to allow the first and second layers to diffuse together to form the alloy finish comprising the nickel and the tin.
